(19) United States
(12) Patent Application Publication
(10) Pub. No.: US 2019/0065240 A1
(43) Pub. Date: Feb. 28, 2019

(54) ELECTRONIC DEVICE FOR CONTROLLING MULTIPLE-WINDOWS AND OPERATION METHOD THEREOF

(71) Applicant: Samsung Electronics Co., Ltd., Suwon-si (KR)

(72) Inventors: Kyu-Chul KONG, Gumi-si (KR); Dae-Sik HWANG, Daegu (KR); Ju-Hyun JEONG, Gumi-si (KR); Yong-Kwon KIM, Busan (KR); Jong-Wu BAEK, Gumi-si (KR)

(21) Appl. No.: 16/108,448

(22) Filed: Aug. 22, 2018

(30) Foreign Application Priority Data
Aug. 22, 2017 (KR) 10-2017-0106349

(51) Int. Cl. G06F 9/48; G06F 3/0488; G06F 3/0481; G06F 3/0483

(52) U.S. Cl. CPC G06F 9/485; G06F 3/04886; G06F 3/0483; G06F 3/04817; G06F 9/4818

(57) ABSTRACT

An electronic device, a method and computer-readable medium is disclosed. The electronic device includes a housing; a touch screen display; a wireless communication circuit; a processor; and a memory. The memory is configured to store a first application program including a first user interface, a second application program including a second user interface, and instructions. The processor is configured to display an array of icons. At least one of the icons includes a first object and a second object. The processor is configured to receive an input to select one of the at least one of the array of icons. The processor is configured to display the first user interface and the second user interface in sequence on the display upon receiving the input. The processor is configured to repeatedly running the first application program and the second application program alternately in the foreground during a first time period.

### CROSS-REFERENCE TO RELATED APPLICATION

This application claims the priority under 35 U.S.C. § 119(a) to Korean Patent Application Serial No. 10-2017-0106349, which was filed in the Korean Intellectual Property Office on Aug. 22, 2017, the entire content of which is hereby incorporated by reference.

### BACKGROUND

### 1. Field

The present disclosure relates to an electronic device for controlling multiple-windows and an operation method thereof.

### 2. Description of the Related Art

Electronic devices may provide a multi-window function so that a user can use one or more functions together. For example, an electronic device may drive at least two applications on one screen via a multi-window function, making it easy for users to conveniently use the electronic device.

In order to control a plurality of applications at the same time, an electronic device can execute the plurality of applications together. The electronic device provides multiple-windows corresponding to the execution screens of a plurality of applications, whereby accessibility to a plurality of functions and simultaneous usability thereof may increase.

### SUMMARY

In the case where an electronic device executes a multi-window function, while a plurality of applications do not have the focus at the same time and only one application can have the focus among the plurality of applications, the plurality of applications can be executed substantially one by one. When the electronic device provides a multi-window function corresponding to the plurality of applications and the plurality of applications are executed substantially one by one, a window screen may not be displayed due to incomplete initialization of an application, or the window screen may not include accurate data even though the window screen is displayed.

According to various embodiments, when an electronic device provides a multi-window function corresponding to a plurality of applications, the electronic device may control a limited amount of resources (graphics, sounds, focuses, or the like) related to driving an application.

According to various embodiments, when an electronic device sequentially executes a plurality of applications in order to provide a multi-window function corresponding to the plurality of applications, the electronic device may stably complete the initialization of the plurality of applications.

According to various embodiments, an electronic device may include: a housing; a touch screen display exposed through a portion of the housing; a wireless communication circuit positioned in the housing; a processor electrically connected to the touch screen display and the communication circuit; and a memory electrically connected to the processor, wherein the memory is configured to store a first application program including a first user interface, and a second application program including a second user interface, and wherein the memory further stores instructions that, when executed, cause the processor to: display an array of icons on the touch screen display, wherein each of the icons generally has a first size, and wherein at least one of the icons contains a first object and a second object that have a second size smaller than the first size, wherein the first object represents the first application program and the second object represents the second application program; receive an input to select one of the at least one of the icons; from a first point in time, display the first user interface and the second user interface in sequence on the touch screen display upon receiving the input; and repeatedly running the first application program and the second application program to alternately run in the foreground during a first time period from the first point in time.

According to various embodiments, a method of controlling multiple-windows by an electronic device may include: displaying an array of icons on a touch screen display of the electronic device, wherein each icon generally has a first size, and wherein at least one of the icons contains a first object and a second object that have a second size smaller than the first size, wherein the first object represents the first application program and the second object represents the second application program; receiving an input for selecting one of the at least one of the icons; from a first point in time, displaying, a first user interface and a second user interface in sequence on the touch screen display upon receiving the input; and repeatedly running the first application program and the second application program to alternately run in the foreground during a first time period from the first point in time.

According to various embodiments, a computer-readable recording medium may store instructions which are configured to enable a processor to perform at least one operation, wherein the at least one operation may include: displaying an array of icons on a touch screen display, wherein each icon generally has a first size, and wherein at least one of the icons contains a first object and a second object that have a second size smaller than the first size, wherein the first object represents the first application program and the second object represents the second application program; receiving an input for selecting one of the at least one of the icons; from a first point in time, displaying a first user interface and a second user interface in sequence on the touch screen display upon receiving the input; and repeatedly running the first application program and the second application program to alternately run in the foreground during a first time period from the first point in time.

According to various embodiments, an electronic device stably controls a limited amount of resources related to driving of an application even when the electronic device runs a plurality of applications together.

According to various embodiments, an electronic device may stably display execution screens of a plurality of applications in multiple-windows even when only one of the plurality of applications has the focus.

According to various embodiments, an electronic device secures stable initialization of applications that form multiple-windows, thereby preventing a white screen, incorrect screen display, or unexpected termination of an application, which may be caused by unstable initialization at the time of initial driving.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates a block diagram of an electronic device in a network environment according to various embodiments of the present disclosure;

FIG. 2 illustrates a block diagram of a program according to various embodiments of the present disclosure;

FIG. 3 illustrates a block diagram of a program for controlling a plurality of applications together according to various embodiments of the present disclosure;

FIGS. 4A and 4B illustrate diagrams of an example situation of generating an icon for executing a plurality of applications together according to various embodiments of the present disclosure;

FIGS. 5A and 5B illustrate diagrams of example situations of selecting an icon for executing a plurality of applications together according to various embodiments of the present disclosure;

FIGS. 6A and 6B illustrate diagrams of example situations of displaying a plurality of applications together according to various embodiments of the present disclosure;

FIG. 7 illustrates a flowchart of a method for controlling a plurality of applications together by an electronic device according to various embodiments of the present disclosure;

FIG. 8 illustrates a sequence diagram of a method for controlling two applications together by an electronic device according to various embodiments of the present disclosure;

FIG. 9 illustrates a diagram of an example error screen that occurs when an electronic device controls a plurality of applications together according to various embodiments of the present disclosure;

FIG. 10 illustrates a sequence diagram of a method in which an electronic device performs control such that two applications alternately have the focus during a first time period according to various embodiments of the present disclosure;

FIG. 11 illustrates a graph of the lifetime state of two applications over time while an electronic device executes two applications together according to various embodiments of the present disclosure;

FIG. 12 illustrates a flowchart of a method for controlling a plurality of applications together by an electronic device according to various embodiments of the present disclosure;

FIG. 13 illustrates a flowchart of a method for controlling a plurality of applications together by an electronic device according to various embodiments of the present disclosure;

FIGS. 14A and 14B illustrate diagrams of an example situation of executing a plurality of applications together on a lock screen according to various embodiments of the present disclosure; and

FIG. 15 illustrates a flowchart of a method for executing a plurality of applications together by an electronic device on a lock screen according to various embodiments of the present disclosure.

### DETAILED DESCRIPTION

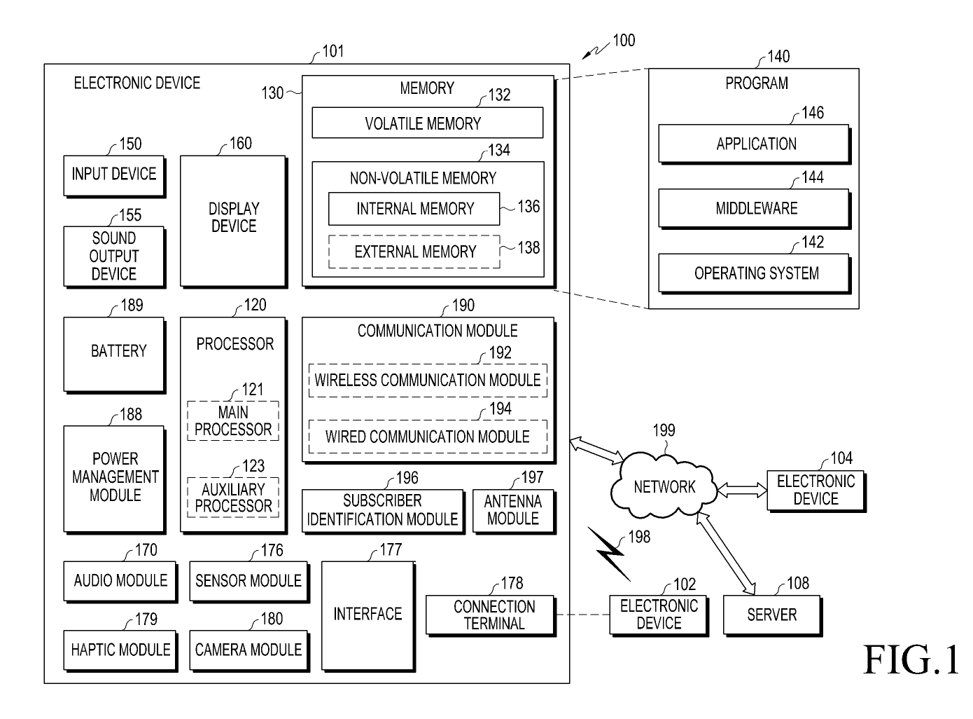

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 illustrates a block diagram illustrating an electronic device 101 in a network environment 100 according to various embodiments of the present disclosure. Referring to FIG. 1, in the network environment 100, the electronic device 101 may communicate with an electronic device 102 via a first network 198 (e.g., short-range wireless communication), or may communicate with an electronic device 104 or a server 108 via a second network 199 (e.g., long-distance wireless communication). According to an embodiment, the electronic device 101 may communicate with the electronic device 104 via the server 108. According to an embodiment, the electronic device 101 may include a processor 120, a memory 130, an input device 150, a sound output device 155, a display device 160, an audio module 170, a sensor module 176, an interface 177, a haptic module 179, a camera module 180, a power management module 188, a battery 189, a communication module 190, a subscriber identification module 196, and an antenna module 197. According to embodiments, the electronic device 101 may omit at least one element (e.g., the display device 160 or the camera module 180) from among all of the elements, or may add other elements. According to the embodiments, some elements may be integrated, such as the case in which the sensor module 176 (e.g., a fingerprint sensor, an iris sensor, or an illumination sensor) is embedded in the display device 160 (e.g., a display).

The processor 120 may drive, for example, software (e.g., the program 140) so as to control at least one other element (e.g., a hardware or software element) of the electronic device 101 connected to the processor 120, and may process and perform operations on various data. The processor 120 may load commands or data received from other elements (e.g., the sensor module 176 or the communication module 190) in the volatile memory 132, may process the loaded commands or data, and may store resultant data in the nonvolatile memory 134. According to an embodiment, the processor 120 may include a main processor 121 (e.g., a central processing unit or an application processor) and a sub-processor 123 (e.g., a graphic processing device, an image signal processor, a sensor hub-processor, or a communication processor) which operates independently from the main processor 121, additionally or alternatively uses lower power than that of the main processor 121, or is specific to a designated function. Here, the sub-processor 123 may operate separately from the main processor 121, or may operate in the state of being embedded therein.

In this instance, the sub-processor 123 may control a function associated with at least one element (e.g., the display device 160, the sensor module 176, or the communication module 190) of the elements of the electronic device 101 or at least a part of their states on behalf of the main processor 121 while the main processor 121 is in an inactive state (e.g., a sleep state), or together with the main processor 121 while the main processor 121 is in an active state (e.g., executing an application). According to an embodiment, the sub-processor 123 (e.g., an image signal processor or a communication processor) may be implemented as a part of another element (e.g., the camera module 180 or the communication module 190) that is functionally related thereto. The memory 130 may store various kinds of data, for example, software (e.g., the program 140), which is used by at least one element (e.g., the processor 120 or the sensor module 176) of the electronic device 101, and input data or output data associated with commands related to the at least one element. The memory 130 may include the volatile memory 132 or the nonvolatile memory 134.

The program 140 may be software stored in the memory 130, and may include, for example, the operating system 142, the middleware 144, or the application 146.

The input device 150 may be a device for receiving commands or data which are to be used for elements (e.g., the processor 120) of the electronic device 101, from the outside (e.g., a user) of the electronic device 101, and may include, for example, a microphone, a mouse, or a keyboard.

The sound output device 155 may be a device for outputting a sound signal to the outside of the electronic device 101, and may include, for example, a speaker which is used for general purposes, such as multimedia playback or transcription playback, and a receiver which is used for the purpose of receiving a phone call. According to an embodiment, the receiver may be configured to be integrated with a speaker, or may be configured separately from a speaker.

The display device 160 is a device for providing visual information to the user of the electronic device 101, and may include, for example, a display, a hologram device, or a projector, as well as a control circuit for controlling a corresponding device. According to an embodiment, the display device 160 may include touch circuitry or a pressure sensor for measuring the pressure intensity of a touch.

The audio module 170 may bidirectionally convert sound and an electronic signal. According to an embodiment, the audio module 170 may obtain sound using the input device 150, or may output sound via the sound output device 155 or an external electronic device (e.g., the electronic device 102 (e.g., a speaker or a headphone) connected to the electronic device 101 in a wired or wireless manner.

The sensor module 176 may generate an electrical signal or data value corresponding to the internal operation state (e.g., power or temperature) of the electronic device 101 or an external environmental state. The sensor module 176 may include, for example, a gesture sensor, a gyro sensor, an atmospheric pressure sensor, a magnetic sensor, an acceleration sensor, a grip sensor, a proximity sensor, a color sensor, an Infrared (IR) sensor, a biometric sensor, a temperature sensor, a humidity sensor, or an illumination sensor.

The interface 177 may support a designated protocol that is connected to an external electronic device (e.g., the electronic device 102) in a wired or wireless manner. According to an embodiment, the interface 177 may include a high-definition multimedia interface (HDMI), a universal serial bus (USB) interface, an SD card interface, or an audio interface.

A connection terminal 178 may include a connector that physically connects the electronic device 101 and an external electronic device (e.g., the electronic device 102), for example, an HDMI connector, a USB connector, an SD card connector, or an audio connector (e.g., a headphone connector).

A haptic module 179 may convert an electrical signal into a mechanical stimulus (e.g., vibration or movement) or an electrical stimulus that a user can recognize via a sense of touch or movement. The haptic module 179 may include, for example, a motor, a piezoelectric effect element, or an electrostimulator.

The camera module 180 may shoot a still image and a video. According to an embodiment, the camera module 180 may include one or more lens, an image sensor, an image signal processor, or a flash.

The power management module 188 may be a module for managing power supplied to the electronic device 101, and may be configured as, for example, at least a part of a power management integrated circuit (PMIC).

The battery 189 is a device for supplying power to at least one element of the electronic device 101, and may include, for example, a primary cell which is not rechargeable, a secondary cell which is rechargeable, or a fuel cell.

The communication module 190 may establish a wired or wireless communication channel between the electronic device 101 and an external electronic device (e.g., the electronic device 102, the electronic device 104, or the server 108), and may support communication via the established communication channel. The communication module 190 may include one or more communication processors which operate independently from the processor 120 (e.g., an application processor), and support wired or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication module), and may communicate with an external electronic device via a first network 198 (e.g., a short-range communication network such as Bluetooth, Wi-Fi direct, or Infrared Data Association (IrDA)) or a second network 199 (e.g., a long-distance communication network such as a cellular network, the Internet, or a computer network (e.g., LAN or WAN)) using a corresponding communication module among the described communication modules. The above-described various types of communication modules (communication module 190) may be implemented by one chip, or may be implemented by separate chips.

According to an embodiment, the wireless communication module 192 may identify and authenticate the electronic device 101 within a communication network using user information stored in the subscriber identification module 196.

The antenna module 197 may include one or more antennas for transmitting or receiving signals or power to/from the outside. According to an embodiment, the communication module 190 (e.g., the wireless communication module 192) may transmit a signal to an external electronic device, or may receive a signal from an external electronic device, via an antenna appropriate for the communication scheme.

Some of the elements may be connected to each other via a communication scheme of neighboring devices (e.g., a bus, a general purpose input/output (GPIO), a serial peripheral interface (SIP), or a mobile industry processor interface (MIPI)), and may mutually exchange signals (e.g., commands or data).

According to an embodiment, commands or data may be transmitted or received between the electronic device 101 and the external electronic device 104 via the server 108 connected to the second network 199. Each electronic device 102 and 104 may be of a type that is the same as, or different from, that of the electronic device 101. According to an embodiment, all or some of the operations executed by the electronic device 101 may be executed by another external electronic device or a plurality of external electronic devices. According to an embodiment, when the electronic device 101 has to perform some functions or services automatically or in response to a request, the electronic device 101 may request an external electronic device to perform at least some functions relating thereto instead of, or in addition to, performing the functions or services by itself. The external electronic device that receives the request may execute the requested function or additional function, and may transmit the result thereof to the electronic device 101. The electronic device 101 may provide the received result as it is, or may additionally process the received result to provide the requested functions or services. To this end, for example, cloud-computing, distributed-computing, or client-server-computing technology may be used.

According to various embodiments, the electronic device 101 may include a housing, a touch screen display (e.g., the display device 160 or the input device 150) exposed through a portion of the housing, a wireless communication circuit (e.g., the wireless communication module 192) positioned in the housing, a processor (e.g., the processor 120) electrically connected to the display device 160 and to the wireless communication module 192; and a memory (e.g., the memory 130), which is electrically connected to the processor 120 and stores a first application program including a first user interface and a second application program including a second user interface.

According to various embodiments, the electronic device 101 may display an array of icons on the display device 160. Each icon generally has a first size, at least one of the icons includes a first object and a second object that have a second size smaller than the first size, the first object represents the first application program, and the second object represents the second application program.

According to various embodiments, the electronic device 101 may receive input for selecting one of at least one of the icons.

According to various embodiments, the electronic device 101 may display, from a first point in time, the first user interface and the second user interface in sequence on the display device 160 upon receiving the input.

According to various embodiments, the electronic device 101 may repeatedly run the first application program and the second application program to alternately run in the foreground during a first time period from the first point in time.

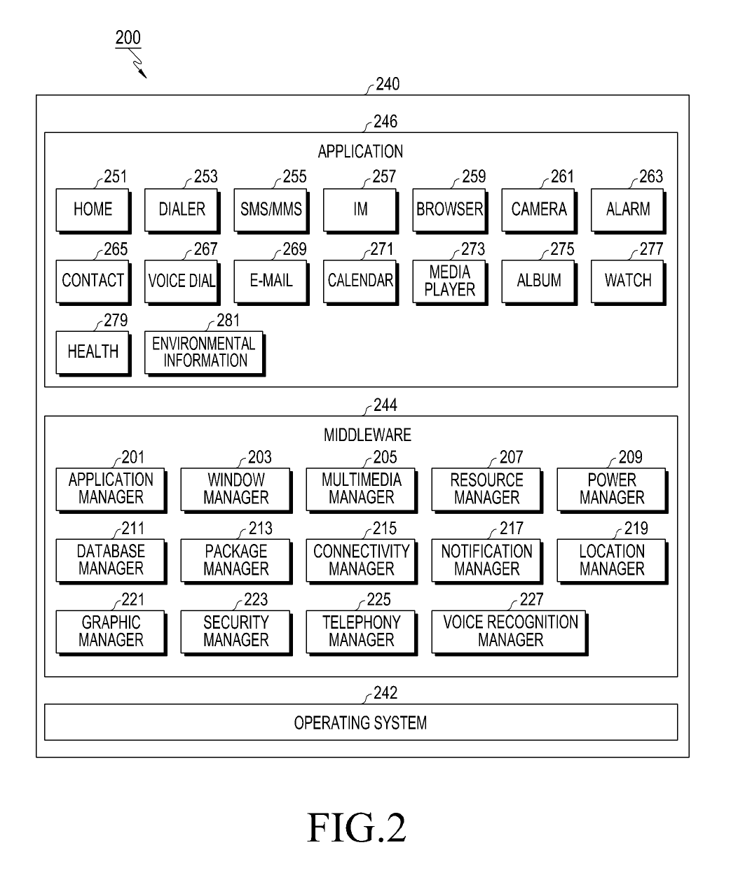

FIG. 2 illustrates a block diagram 200 of a program 240 according to various embodiments of the present disclosure. According to an embodiment, the program 240 may include an operating system 242 for controlling one or more resources of an electronic device (e.g., the electronic device 101 of FIG. 1), middleware 244, or an application 246 executable on the operating system 242. The operating system 242 may include, for example, ANDROID, IOS, WINDOWS, SYMBIAN, TIZEN, or BADA. For example, at least some of the program 240 may be preloaded to the electronic device 101 when the electronic device 101 is manufactured, or may be downloaded from an external electronic device (e.g., the electronic device 102 or 104 or the server 108) or updated in a service environment of a user.

The operating system 242 may control (e.g., allocate or retrieve) system resources (e.g., a process, a memory, or a power source) of the electronic device 101. Additionally or alternatively, the operating system 242 may include one or more driver programs for driving other hardware devices of the electronic device 101, for example, the input device 150, the sound output device 155, the display device 160, the audio module 170, the sensor module 176, the interface 177, the haptic module 179, the camera module 180, the power management module 188, the battery 189, the communication module 190, the subscriber identification module 196, or the antenna module 197.

The middleware 244 may provide various functions to the applications 246 so that the applications 246 use functions or information provided by one or more resources of the electronic device 101. For example, the middleware 244 may include an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227. The application manager 201 may manage, for example, the lifetime of the applications 246. The window manager 203 may, for example, manage graphical user interface (GUI) resources used for a screen. The multimedia manager 205 may identify formats required for reproducing various media files and may encode or decode a media file using a codec suitable for a corresponding format. The resource manager 207 may, for example, manage the source code of the applications 246 or space in memory. The power manager 209 may manage, for example, battery capacity, temperature, or power, and may determine or provide power information required for the operation of the electronic device 101 based on corresponding information. According to an embodiment, the power manager 209 may interoperate with a basic input/output system (BIOS).

The database manager 211 may, for example, generate, search, or change databases to be used by the applications 246. The package manager 213 may, for example, manage the installation or update of an application that is distributed in the form of a package file. The connectivity manager 215 may, for example, manage a wireless or wired connection between the electronic device 101 and an external electronic device. The notification manager 217 may, for example, provide a function of informing a user of an event that occurs (e.g., a call, a message, or an alarm). The location manager 219 may, for example, manage the location information of the electronic device 101. The graphic manager 221 may manage a graphic effect to be provided to a user and a user interface relating to the graphic effect. The security manager 223 may provide, for example, system security or user authentication. The telephony manager 225 may, for example, manage a voice call function or a video call function of the electronic device 101. The voice recognition manager 227 may, for example, transmit voice data of a user to the server 108, and receive a command, which corresponds to a function to be executed by the electronic device 101 based on the corresponding voice data, or text data converted based on the corresponding voice data. According to an embodiment, the middleware 244 may dynamically delete some of the existing elements, or may add new elements. According to an embodiment, at least a part of the middleware 244 may be included as a part of the operating system 242, or may be implemented as software which is separate from the operating system 242.

The applications 246 may include, for example, home 251, a dialer 253, SMS/MMS 255, an instant messaging (IM) application 257, a browser 259, a camera 261, an alarm 263, contacts 265, voice recognition 267, e-mail 269, a calendar 271, a media player 273, an album 275, a watch 277, a health-care application 279 (e.g., for measuring exercise quantity or blood glucose), an environmental information application 281 (e.g., atmospheric pressure, humidity, or temperature information), and the like. According to an embodiment, the applications 246 may further include an information exchange application (not illustrated) that can support the exchange of information between the electronic device 101 and an external electronic device. The information exchange application may include, for example, a notification relay application for relaying predetermined information (e.g., a call, a message, or an alarm) to an external electronic device, or a device management application for managing an external electronic device. The notification relay application may, for example, transfer notification information corresponding to an event (e.g., reception of an e-mail) occurring in another application (e.g., the e-mail application 269) of the electronic device 101 to an external electronic device, or may receive notification information from an external electronic device and may provide the same to a user of the electronic device 101. The device management application may control, for example, an external electronic device that communicates with the electronic device 101, and a power source (e.g., turning on or off) or a function (e.g., brightness, resolution, or focus) of some elements of the external electronic device (e.g., the display device 160 or the camera module 180). Additionally or alternatively, the device management application may support the installation, deletion, or update of an application that operates in an external electronic device.

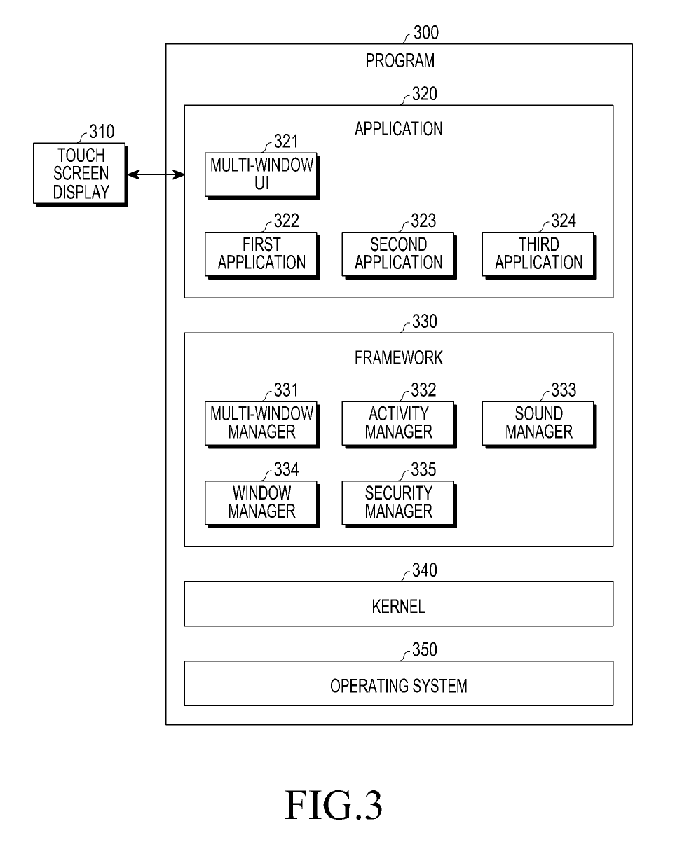

FIG. 3 illustrates a block diagram of a program and a touch screen display for controlling a plurality of applications together according to various embodiments of the present disclosure. According to various embodiments, an electronic device (e.g., the electronic device 101 of FIG. 1) may drive a program 300 (e.g., the program 240 of FIG. 2) including an application 320 (e.g., the application 246 of FIG. 2), a framework 330 (e.g., the middleware 244 of FIG. 2), a kernel 340 (e.g., the middleware 244 of FIG. 2), and an operating system 350 (e.g., the operating system 242 of FIG. 2).

According to various embodiments, the application 320 may include a user interface, and may provide an execution screen of an application on a touch screen display 310 (e.g., the display device 160 of FIG. 1) via the user interface, and may receive user input from the touch screen display 310 (e.g., the input device 150 of FIG. 1). For example, the application 320 may provide a shortcut icon for executing a plurality of applications together on the touch screen display 310 via the user interface, and the touch screen display 310 may display the shortcut icon. The application 320 may detect user input for designating a shortcut icon via the touch screen display 310, and may receive the user input via the user interface.

According to various embodiments, the application 320 may include a multi-window UI 321, a first application 322, a second application 323, and a third application 324. For example, the multi-window UI 321 may provide a user interface for executing an application based on user input. As another example, the multi-window UI 321 may display information associated with at least one application in the form of a list. As another example, the multi-window UI 321 may drive at least one application based on an execution command, such as a user touch input, a pen input, a voice command, and the like, and may enable a predetermined operation of the driven application to be executed. Each application (e.g., the first application 322, the second application 323, and the like) included in the program 300 may be independently stored in a memory (e.g., the memory 130 of FIG. 1) included in the electronic device 101, and may be independently executed. As another example, the applications 320 may provide a function related therebetween, or may transmit or receive data between the applications 320 when the applications 320 are executed. For example, the multi-window UI 321 may include a user interface, may display a shortcut icon for driving the first application 322 and the second application 323 together via the user interface, and may call a creation function for executing the first application and the second application together in response to input on the shortcut icon, which is detected by the touch screen display 310. The multi-window UI displays information associated with an icon for executing an application in the form of a main menu, a shortcut menu, an edge menu, or the like, and may execute (launch) an application. For example, the multi-window UI may be a quick menu.

According to various embodiments, the framework 330 may indicate various modules designed and implemented for use in the program 300. Referring to FIG. 3, the framework 330 may include a multi-window manager 331, an activity manager 332, a sound manager 333, a window manager 334, and a security manager 335.

According to various embodiments, the multi-window manager 331 may provide a function required to operate a plurality of applications in multiple-windows. For example, the multi-window manager 331 may correct a problem occurring after the multiple-windows are executed, or may provide a function of performing exception handling.

According to various embodiments, the activity manager 332 may provide a function of managing the lifetime of an application object, that is, the lifetime of the activity. For example, the application object may have lifetime stages including a create stage, a start stage, a resume state, a pause stage, a stop stage, and a destroy stage. For example, all of the lifetime stages of the activity may collectively indicate the period from the point at which a creation function for an application (e.g., an onCreate( ) function) is called to the point at which a destroy function (e.g., an onDestroy( ) function) is called. The entire lifetime may include the visible lifetime of the activity. The visible lifetime may include the foreground lifetime. The activity during the visible lifetime stage may indicate, for example, the period from the point at which a start function (e.g., an onStart( ) function) for the application is called to the point at which a stop function (e.g., an onStop( ) function) is called. According to various embodiments, the activity during the visible lifetime stage may include reception of user input for the application, and the application may be displayed on a screen.

According to various embodiments, the activity at the foreground lifetime stage may indicate, for example, the period from the point at which a resume function (e.g., an onResume( ) function) for the application is called to the point at which a pause function (e.g., an onPause( ) function) is called. For example, while the activity of the application is in the foreground lifetime stage, it is considered that the application is in a foreground state. When the application is in the foreground state, execution code for the application is executed (running). As another example, when the activity of the application is included in the visible lifetime stage but the execution (running) of the application is paused, it is considered that the application is in a background state. The background state may indicate the period from the point at which a pause function (e.g., an onPause( ) function) for the application is called before the point at which a resume function (e.g., an onResume( ) function) is called. In the background state, the application may receive user input for the application and the application may be displayed on the screen, but execution code for the corresponding operation may not be executed (running).

According to various embodiments, the fact that an application has the focus indicates that the application is in the foreground state, which indicates a period from the point at which a resume function for the application is called until the point at which a pause function is called. As another example, the fact that the application does not have the focus indicates that the application is in the background state, and indicates the period from the point at which a pause function for the application is called until the point at which a resume function is called. Both the foreground state and the background state are included in the visible lifetime stage, and thus the activity of the corresponding application is generated, and the execution screen of the application may be displayed on the touch screen display 310.

According to various embodiments, the sound manager 333 may provide a function of allocating and controlling a sound resource based on the operation of the activity. For example, when the first application 322 is in the foreground state and sound reproduction is requested by the first application 322, the sound manager 333 may output a corresponding sound via an output module. As another example, when the first application 322 is in the background state and sound reproduction is requested by the first application 322, the sound manager 333 may not output a corresponding sound.

According to various embodiments, the window manager 334 may configure a window to be displayed on the touch screen display 310 based on a view state of the activity, and may provide a function of controlling drawing, viewing, and focus in association with the window. For example, when both the first application 322 and the second application 323 are in the visible state, the window manager 334 may display the first application 322 and the second application 323 on the touch screen display 310.

According to various embodiments, the security manager 335 may provide a function of controlling a locked state or unlocked state for performing the activity. The security manager 335 may determine whether to perform unlocking for execution for each application. When unlocking is required, the security manager 335 may request the window manager 334 to display an icon for unlocking or the like.

According to various embodiments, the kernel 340 may be a module that provides various functions for driving the operating system 350, and may be defined and implemented differently depending on the type of operating system 350. For example, the kernel 340 may be one of the middleware 244 of FIG. 2.

According to various embodiments, the operating system 350 may indicate a general manager that is capable of managing every piece of hardware and software that was described in the descriptions of the operating system 242 of FIG. 2.

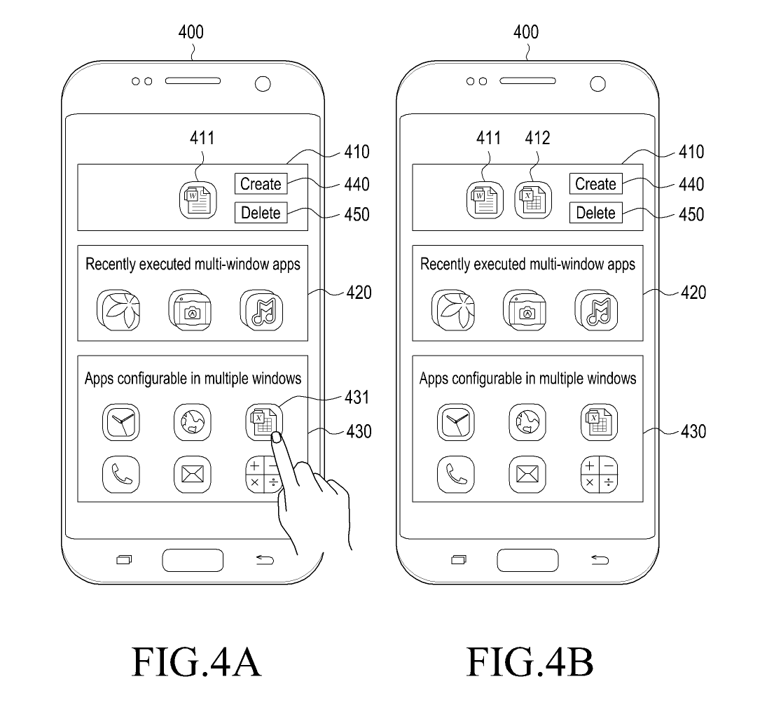

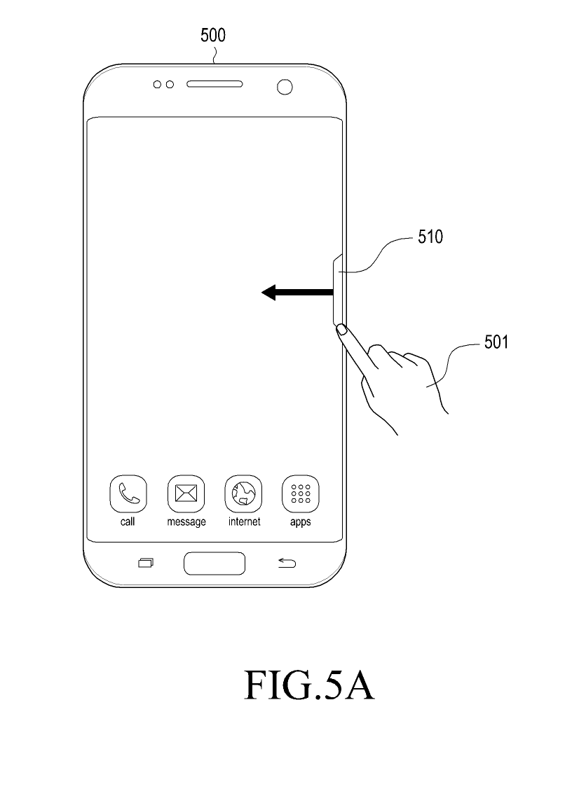

FIGS. 4A and 4B illustrate diagrams of an example situation of generating an icon for executing a plurality of applications together according to various embodiments of the present disclosure. According to various embodiments, an electronic device 400 (e.g., the electronic device 101 of FIG. 1) may display, on a display, a shortcut icon for receiving user input for executing a plurality of applications together. In FIG. 4A, according to various embodiments, the electronic device 400 may display a user interface on the screen of the display, the user interface including an area 410 for displaying an application selected to be executed in multi-window, an area 420 for displaying recently executed multi-window applications (apps), and an area 430 for displaying applications (apps) which may be provided to a user in multi-window. In FIG. 4A, the electronic device 400 may display, on the area 410, an icon 411 indicating a Word application selected by the user. The electronic device 101 may add an application desired to be executed together with the Word application, based at least partially on an input. For example, one of the plurality of applications displayed in the area 430 may be selected. For example, in FIG. 4A, an icon 431 indicating an Excel application selected by the user may be displayed as an icon 412 indicating the Excel application in the area 410 for displaying applications selected to be executed in multiple-windows.

According to various embodiments, the electronic device 400 (e.g., the electronic device 101 of FIG. 1) may provide a create button 440 and a delete button 450 in the area 410 of FIGS. 4A and 4B. When the create button 440 is selected, the electronic device 400 may create, in the area 410, a shortcut icon for executing the plurality of applications together. When the delete button 450 is selected, the electronic device 400 may delete the shortcut icon displayed in the area 410. According to an embodiment, the electronic device 400 may determine the priorities of the plurality of applications provided in the multiple-windows. For example, the electronic device 400 may set the priorities of the plurality of applications based at least partially on the order selected by the user. For example, an application selected earlier may have a higher priority. For example, it is assumed that as a number indicating a priority has a small value, the priority is high. In FIG. 4B, when the priority of the Word application 411, which is selected earlier, is 1, the priority of the Excel application 412, which is selected later, is 2. A plurality of applications may be provided together to the user on one screen. For example, when executing a plurality of applications, the electronic device 400 may sequentially start the plurality of applications. For example, the plurality of applications may sequentially start according to priorities thereof. When simultaneous execution of the plurality of applications is requested, and focus on all of the plurality of applications after the simultaneous execution is completed is not permitted, the electronic device 400 may focus on an application having a high priority. As another example, when two applications are displayed in multiple-windows, the electronic device 400 may display an application having a high priority in an upper portion of the display and may display an application having a low priority in a lower portion of the display.

According to various embodiments, the electronic device 400 may store a shortcut icon for executing a plurality of applications together, in the memory of the electronic device 400. For example, the electronic device 400 may store the shortcut icon including information associated with the shortcut icon. For example, the electronic device 400 may store a shortcut icon, including information, such as an identifier for identifying an icon for executing a plurality of applications together in multiple-windows, a list of applications to be executed together in multiple-windows, information associated with the order of applications to be displayed on a screen, a layout information of each application, a thumbnail image including icons indicating applications, priorities of applications in association with user input, priorities of applications in association with sound output, and the like.

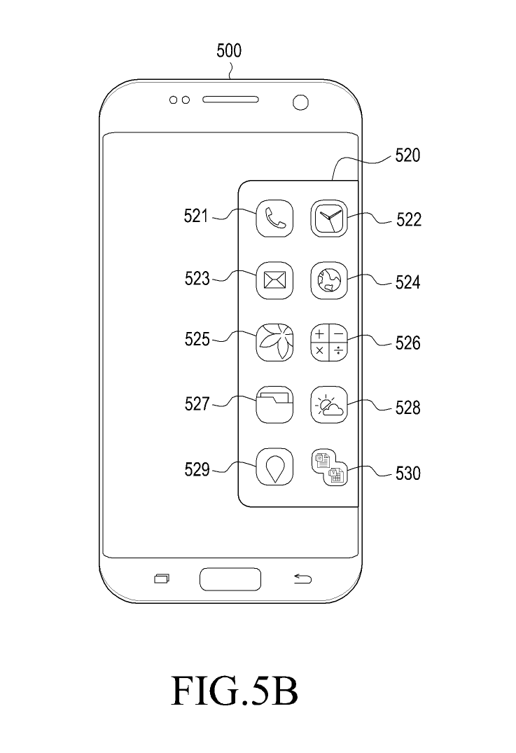

FIGS. 5A and 5B illustrate diagrams of example situations of selecting an icon for executing a plurality of applications together according to various embodiments of the present disclosure. According to various embodiments, an electronic device 500 (e.g., the electronic device 101 of FIG. 1) may display a home screen, as shown in FIG. 5A. According to an embodiment, the electronic device 500 may dispose an edge menu at a boundary on the right side of a home screen. For example, the electronic device 500 may display the edge menu as a hidden state 510 as shown in FIG. 5A, before a user input (e.g., a flick) occurs. For example, in response to the user input 501 as illustrated in FIG. 5A, the electronic device 500 may display the edge menu 520 in a partial area at the right side of the home screen, as illustrated in FIG. 5B. The electronic device 101 may display an edge menu at the upper side, the lower side, the left side, and the right side of the home screen in response to input detected at the upper side, the lower side, the left side, and the right side of the display. According to an embodiment, an edge menu may include a plurality of icons. For example, the plurality of icons may include a shortcut icon for executing a single application or a shortcut icon for executing a plurality of applications. According to an embodiment, the electronic device 500 may display an array of icons on a touch screen display. For example, the electronic device 500 may display approximately 10 icons in the edge menu 520, as illustrated in FIG. 5B. For example, the icons may substantially have a first size. As another example, at least one of the icons may include a first object and a second object having a second size that is smaller than the first size. The first object and the second object may indicate different applications. For example, the electronic device 500 may execute a single application in response to input on a shortcut icon 521 for a call application, a shortcut icon 522 for a time application, a shortcut icon 523 for an e-mail application, a shortcut icon 524 for a web-browser application, a shortcut icon 525 for a gallery application, a shortcut icon 526 for a calculator application, a shortcut icon 527 for a document application, a shortcut icon 528 for a weather application, or a shortcut icon 529 for a map application. As another example, when input is performed on a shortcut icon 530 for executing a Word application and an Excel application together, the electronic device 101 may execute the plurality of applications together, and may display execution screens of the plurality of applications together in multiple-windows. For example, when the icons 521, 522, . . . , and 529 for executing single applications have a first size, the icon 530 for executing the plurality of applications together may include a first icon object a second object having a second size that is smaller than the first size. In FIG. 5B, the shortcut icon 530 may indicate a first object indicating a Word application and a second object indicating an Excel application.

According to various embodiments, the electronic device 500 may display the shortcut icon 530, which is generated according to a method of generating a shortcut icon for executing a plurality of applications of FIGS. 4A and 4B together, in the edge menu 520, as illustrated in FIG. 5B.

Referring to FIG. 5B, when a shortcut icon provided in the edge menu is selected based at least partially on a user input (e.g., a touch on a touch screen or the like), the electronic device 500 (e.g., the electronic device 101 of FIG. 1) may execute a plurality of applications included in the shortcut icon, and may provide multiple-windows corresponding to the plurality of applications. Although an icon is displayed in the form of an edge menu in FIGS. 5A and 5B, various embodiments are not limited thereto. According to various embodiments, the electronic device 500 may display an icon for receiving user input for executing a plurality of applications together in various locations, such as a menu generated by a predetermined input (e.g., user input performed by pressing a button of an electronic pen), a menu displayed on a home screen, a lock screen, or the like. As another example, the electronic device 500 may display an icon for executing a plurality of applications in a full menu that displays all of the icons. The electronic device 500 may provide a shortcut icon via various user interfaces. The above-described menus may be provided in combinations, and may be variously modified.

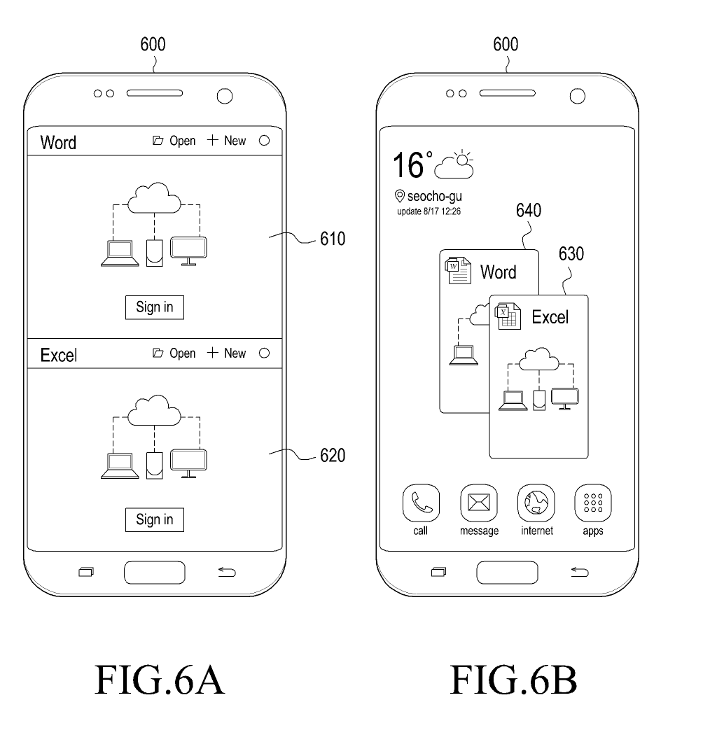

FIGS. 6A and 6B illustrate diagrams of example situations of displaying a plurality of applications together according to various embodiments of the present disclosure.

According to various embodiments, an electronic device 600 (e.g., the electronic device 101 of FIG. 1) may perform control such that a first user interface and a second user interface are displayed at the same size. Referring to FIG. 6A, the electronic device 600 (e.g., the electronic device 101 of FIG. 1) according to various embodiments may display multiple-windows for executing two applications together. For example, in response to a request for executing a Word application and an Excel application together, the electronic device 600 may display multiple-windows. For example, the electronic device 600 may divide a screen of a display into at least two screens, and may display respective applications on the screens resulting from the division.

According to various embodiments, an application may display an execution screen in at least one of the multiple-windows via a user interface. For example, the first user interface included in a first application and the second user interface included in a second application may be displayed on a display such that the first user interface and the second user interface are in contact along a boundary extending perpendicular to an edge of the display (e.g., the display device 160 of FIG. 1). For example, the display may have a rectangular shape in which a first side has a first length and a second size has a second length that is longer than the first length, and the edge may be at least a part of the second side. For example, the screen of the display may be divided into two sub-screens 610 and 620 having the same size, using, as a boundary, a line that vertically divides the second side that has a long length.

According to various embodiments, the electronic device 600 may determine the location where an executed application is to be displayed on the display based on the priority of the executed application. For example, among the Word application and the Excel application, when the Word application has higher priority, the electronic device 600 may display the Word application in the sub-screen 610 that is located in the upper portion of the display, and may display the Excel application, having a relatively low priority, in the sub-screen 620 that is located in the lower portion of the display.

According to various embodiments, there are various methods of providing multiple-windows by dividing the screen of the display into at least two screens. According to an embodiment, the electronic device 600 may divide the screen of the display into two sub-screens using, as a boundary, a line that vertically divides a first side of the screen of the display, which has a relatively short length (a first length). As another example, the boundary of the sub-screens may be implemented as a curve instead of a straight line. According to an embodiment, the sizes of the sub-screens may be the same as, or different from, each other according to the features of applications. For example, in response to the simultaneous execution of a multimedia application and a message application, the electronic device 101 may dispose a first sub-screen corresponding to the multimedia application in the upper portion of the screen of the display at a large size, and may dispose a second sub-screen corresponding to the message application in the lower portion of the screen of the display at a size that is relatively smaller than that of the first sub-screen. According to an embodiment, the electronic device 600 may dispose an application having a high priority among a plurality of applications in the upper portion of the display. However, in the case of an application that requires a large amount of user input, the application may be disposed in the lower portion of the display even though the application has high priority. In addition to the above-described various embodiments, it is clear that multiple-windows may be disposed and displayed in various forms.

FIG. 6B illustrates the case in which multiple-windows for executing a plurality of applications together are provided in the form of a pop-up window.

According to various embodiments, the electronic device 600 (e.g., the electronic device 101 of FIG. 1) may display a window to overlap another window in the form of a pop-up window. For example, the electronic device 600 may display a first user interface included in a first application as a first pop-up window in a display (e.g., the display device 160 of FIG. 1), and may display a second user interface as a second pop-up window in the display (e.g., the display device 160 of FIG. 1), and at least a part of the second pop-up window may be visible. For example, among the Word application and the Excel application, when the Excel application has high priority, the electronic device 600 may display a pop-up window 630 corresponding to the Excel application so as to overlap a pop-up window 640 corresponding to the Word application, as illustrated in FIG. 6B. For example, when a plurality of applications is displayed to overlap one another, the pop-up window 640 corresponding to an application having a low priority (e.g., the Word application) from among the plurality of applications is displayed to overlap the pop-up window 630 of an application having a high priority (e.g., the Excel application). In this instance, at least a part of the pop-up window 640 corresponding to the application having a low priority (e.g., the Word application) may be displayed on the screen. For example, the electronic device 600 may display at least a part of information output by the application having a low priority (e.g., the Excel application) on the screen. In FIG. 6B, at the point in time at which execution of the Word application and the Excel application is requested, the electronic device 600 may perform control such that the Excel application, having high priority, has the focus.

According to various embodiments, when a window is displayed in the form of a pop-up window, as illustrated in FIG. 6B, the electronic device 600 may change the size or the location of a pop-up window based on user input. According to an embodiment, two pop-up windows may be displayed so as not to overlap to each other according to various user inputs. As another example, an application having a low priority from among two applications is displayed in the full screen of the display, and an application having a high priority may be displayed in a part of the screen of the display using a pop-up window.

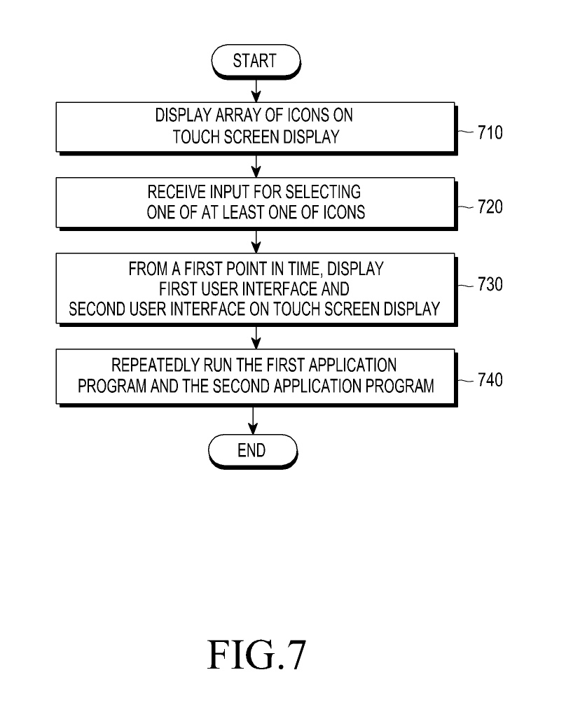

FIG. 7 illustrates a flowchart of a method for controlling a plurality of applications together by an electronic device according to various embodiments of the present disclosure.

In operation 710, according to various embodiments, an electronic device (e.g., the electronic device 101 of FIG. 1) may display an array of icons on a touch screen display. For example, the icons may generally have a first size. As another example, at least one of the icons may include a first object and a second object having a second size, which is smaller than the first size. For example, the first object may indicate a first application, and the second object may indicate a second application.

In operation 720, the electronic device 101 may receive input for selecting one of the at least one of the icons. In response to the input, the electronic device 101 executes the first application and the second application together. For example, the electronic device 101 may execute (launch) the first application, and may then execute the second application.

In operation 730, from a first point in time, the electronic device 101 may display a first user interface and a second user interface on the touch screen display in response to the reception of the input. For example, the first application may include the first user interface, and the second application may include the second user interface.

According to an embodiment, from the first point in time, the electronic device 101 may provide an onCreate method to the first application, may provide an onStart method to the first application, may provide an onResume method to the first application, may provide an onCreate method to the second application, may provide an onStart method to the second application, may provide an onPause method to the first application, may provide an onResume method to the second application, may provide an onPause method to the second application, may provide an onResume method to the first application, may provide an onPause method to the first application, and may provide an onResume method to the second application, sequentially. According to various embodiments, the methods may be functions that call applications. For example, the onCreate method may be an onCreate( ) function. For example, the first point in time may be the point in time at which the second application is executed, after the first application is executed. The first point in time is the point in time at which activity for each of the first application and the second application is created and starts, and the electronic device 101 may provide the first user interface for the first application and the second user interface for the second application. According to various embodiments, the electronic device 101 may perform a predetermined task of each application in response to user input received via the first user interface or the second user interface.

According to various embodiments, the electronic device 101 may identify the priorities set for the first application and the second application, or may set new priorities. For example, when the priority set for the first application is higher than the priority set for the second application, the electronic device 101 may compare the priority of the first application and the priority of the second application, and may perform control so as to preferentially execute the first application based at least on the result of the comparison.

In operation 740, the electronic device 101 may perform control such that the first application and the second application are alternately and repeatedly executed in the foreground during a first time period from the first point in time. For example, the electronic device 101 may provide the onPause method to the second application, may provide the onResume method to the first application, may provide the onPause method to the first application, and may provide the onResume method to the second application. In the state in which the second application has the focus, the electronic device 101 may provide the onPause method to the second application and may provide the onResume method to the first application so as to perform control such that the first application has the focus. As another example, in the state in which the first application has the focus, the electronic device 101 may provide the onPause method to the first application and may provide the onResume method to the second application so as to perform control such that the second application has the focus. When an application has the focus, the application may be in the foreground state, and the electronic device 101 may perform control so as to execute (run) a predetermined execution code for the application that is in the foreground state. The first time period may include, for example, a time for completing initialization required when the first application and the second application are initially executed. For example, the electronic device 101 may designate that the first time period is in the range of two to four seconds.

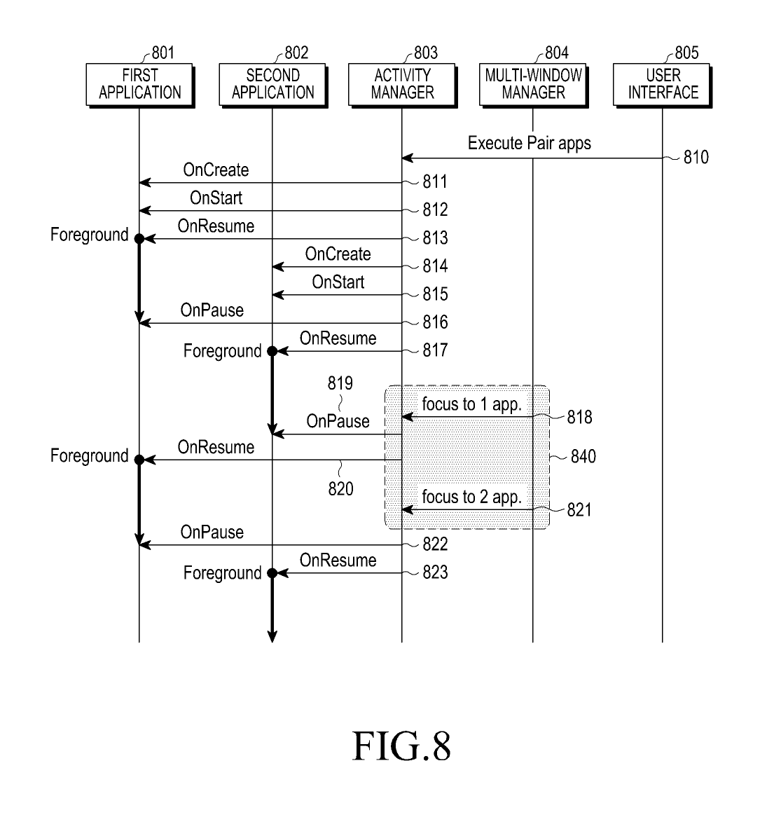

FIG. 8 illustrates a sequence diagram of a method for controlling two applications together by the electronic device 101 according to various embodiments of the present disclosure. According to various embodiments, an electronic device (e.g., the electronic device 101 of FIG. 1) may control a first application 801 and a second application 802, based on at least one of an activity manager 803 (e.g., the activity manager 332 of FIG. 3), a multi-window manager 804 (e.g., the multi-window manager 331 of FIG. 3), and a user interface 805.

In operation 810, the user interface 805 may transmit a request for executing a pair of applications to the activity manager 803. The pair of applications may indicate, for example, the first application 801 and the second application 802. The user interface 805 provides a shortcut icon for executing the pair of applications together, and may execute the pair of applications when the shortcut icon is selected based at least partially on the input.

According to an embodiment, the activity manager 803 identifies priorities set for applications included in the pair of applications, based on information for executing the pair of applications, and executes an application having a high priority first and then executes an application having a low priority later according to an identification result. For example, when the priority set for the first application 801 is higher than the priority set for the second application 802, the activity manager 803 calls a series of execution functions for preferentially executing the first application 801 and then calls a series of execution functions for starting the second application 802. According to an embodiment, the activity manager 803 may sequentially call a creation function (e.g., an OnCreate( ) function), a start function (e.g., an OnStart( ) function), and a resume function (e.g., an OnResume( ) function) for an application, in order to initially execute the application. The activity manager 803 may call, for example, an OnCreate( ) function in operation 811, may call an OnStartOfunction in operation 812, and may call an OnResume( ) function in operation 813, sequentially, with respect to the first application 801. The OnResume( ) function is called in operation 813, and thus the first application 801 is in the foreground state. The activity manager 803 may sequentially call a creation function (e.g., an OnCreate( ) function), a start function (e.g., an OnStart( ) function), and a resume function (e.g., an OnResume( ) function) for the second application 802 in order to start the second application 802. The activity manager 803 may sequentially call the OnCreate( ) function and the OnStart( ) function for the second application 802 in operations 814 and 815, may call the OnPause( ) function for the first application 801 in operation 816, and may call the OnResume( ) function for the second application 802 in operation 817. At the point in time at which operation 817 is performed, the OnPause( ) function has been called for the first application 801 and the OnResume( ) function has not yet been called, it is considered that the first application 801 is in a background state. For example, in operation 817, the OnResume( ) function is called for the second application 802, and thus it is considered that the second application 802 is in the foreground state.

According to an embodiment, the multi-window manager 804 may perform control such that the first application 801 or the second application 802 has the focus in operation 840. For example, the multi-window manager 804 may control the activity manager 803 such that the first application 801 has the focus in operation 818. In response to operation 818, the activity manager 803 may call the OnPause( ) function for the second application 802 having the focus in operation 819, and may call the OnResume( ) function for the first application in operation 820. At the point in time at which operation 820 is performed, the first application 801 may be in the foreground state again. As another example, the multi-window manager 804 may control the activity manager 803 such that the second application 802 has the focus in operation 821. In response to operation 821, the activity manager 803 may call the OnPause( ) function for the first application 801, having the focus, in operation 822, and may call the OnResume( ) function for the second application in operation 823. At the point in time at which operation 823 is performed, the second application 802 may be in the foreground state again.

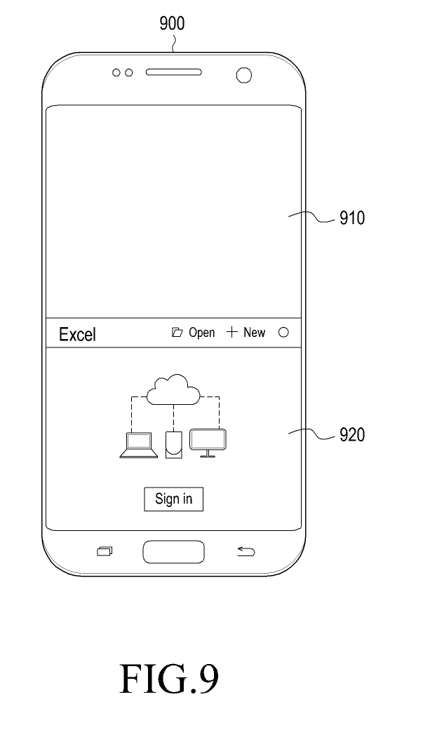

FIG. 9 illustrates a diagram of an example error screen that occurs when an electronic device controls a plurality of applications together according to various embodiments of the present disclosure.

According to various embodiments, an electronic device 900 (e.g., the electronic device 101 of FIG. 1) may implement an application so as not to update a screen or to stop multi-tasking, such as data communication or the like, in the background state, for example, after the OnPause( ) function is called. As illustrated in FIG. 9, in response to a request for executing a Word application and an Excel application together, the electronic device 900 may provide a multi-window including two sub-windows 910 and 920. The multi-window may include the first sub-window 910 corresponding to the Word application and the second sub-window 920 corresponding to the Excel application. When the Word application is initially executed, and the Word application loses the focus before initialization for initial execution thereof is completed, a white screen may occur, such as the first sub-window 910 including an execution screen of the Word application.

As another example, when only one sound path exists, which is allocable to an application, when an application is driven, the electronic device 900 may output only the sound of an application having the focus from among a plurality of applications when the plurality of applications is executed together in a multi-window. For example, reproduction of some of the plurality of applications that are executed together may be terminated.

According to various embodiments, when executing the plurality of applications together according to the method of FIG. 7, the electronic device 900 performs control so as to alternately give the focus to the plurality of applications, whereby an error such as the white screen of FIG. 9 may be removed.

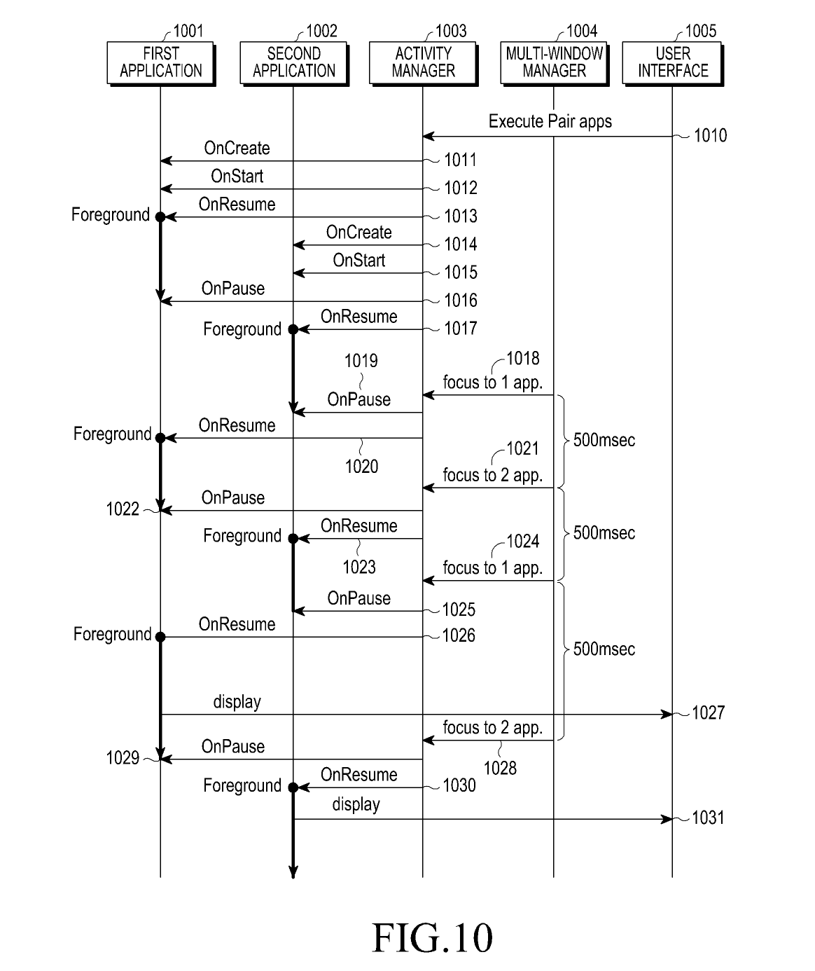

FIG. 10 illustrates a sequence diagram of a method in which an electronic device performs control such that two applications alternately have the focus during a first time period, according to various embodiments of the present disclosure.

According to various embodiments, an electronic device (e.g., the electronic device 101 of FIG. 1) may control a first application 1001 and a second application 1002, based on at least one of an activity manager 1003 (e.g., the activity manager 332 of FIG. 3), a multi-window manager 1004 (e.g., the multi-window manager 331 of FIG. 3), and a user interface 1005.

In operation 1010, the user interface 1005 may transmit a request for executing a pair of applications to the activity manager 1003. The pair of applications may be, for example, the first application 1001 and the second application 1002. The user interface 1005 may provide a shortcut icon for executing the pair of applications together, and may execute the pair of applications when the shortcut icon is selected based at least partially on the input.

According to an embodiment, the activity manager 1003 may sequentially execute the first application 1001 and the second application 1002 in response to the request for executing the pair of applications. For example, the activity manager 1003 may call a series of execution functions for preferentially executing the first application 1001, and then may call a series of execution functions for executing the second application 1002. The activity manager 1003 may sequentially call a creation function (e.g., an OnCreate( ) function), a start function (e.g., an OnStart( ) function), and a resume function (e.g., an OnResume( ) function) for an application, in order to initially execute the application. The activity manager 1003 may call an OnCreate( ) function in operation 1011, may call an OnStart( ) function in operation 1012, and may call an OnResume( ) function in operation 1013, sequentially, with respect to the first application 1001, in order to execute the first application 1001. The OnResume( ) function is called in operation 1013, and thus it is considered that the first application 1001 is in the foreground state. The activity manager 1003 may sequentially call a creation function (e.g., an OnCreate( ) function), a start function (e.g., an OnStart( ) function), and a resume function (e.g., an OnResume( ) function) for the second application 1002 in order to execute the second application 1002. The activity manager 1003 may sequentially call the OnCreate( ) function and the OnStart( ) function for the second application 1002 in operations 1014 and 1015, may call the OnPause( ) function for the first application 1001 in operation 1016, and may call the OnResume( ) function for the second application 1002 in operation 1017 in order to execute the second application 1002. At the point in time at which operation 1017 is performed, the OnPause( ) function has been called and the OnResume( ) function has not yet been called, it is considered that the first application 1001 is in a background state. For example, when the OnResume( ) function has been called and the OnPause function has not yet been called, it is considered that the second application 1002 is in the foreground state. Referring to FIG. 7, in operation 740, the electronic device 101 may perform control such that the first application and the second application alternately and repeatedly have the focus during a first time period from a first point in time. According to an embodiment, the multi-window manager 1004 may control the activity manager 1003 such that the first application and the second application alternately have the focus during a time period until initialization of the first application and the second application are completed. For example, the multi-window manager 1004 may determine, as the first point in time, the point in time at which the second application 1002 is executed in the foreground (e.g., the point in time at which operation 1017 is completed).

According to an embodiment, the multi-window manager 1004 may control the activity manager 1003 such that the first application 1001 has the focus for a predetermined time period (e.g., 500 msec) in operation 1018. For example, the activity manager 1003 may call the OnPause function for the second application 1002 having the focus in operation 1019, and may call the OnResume function for the first application in operation 1020. The first application 1001 may be in the foreground state again. As another example, the multi-window manager 1004 may control the activity manager 1003 such that the second application 1002 has the focus for a predetermined time period (e.g., 500 msec) in operation 1021. For example, as illustrated in FIG. 10, the predetermined period may be 500 msec. The multi-window manager 1004 may perform control such that the first application 1001 and the second application 1002 alternately have the focus during the first time period in order to stably secure initialization that is required for initial execution of the first application 1001 and the second application 1002. For example, the first time period may be determined to be the greatest value among the values corresponding to expected times for initialization of the first application and the second application. For example, as illustrated in FIG. 10, the first time period may be 2 sec. The activity manager 1003 may call the OnPause( ) function for the first application 1001 having the focus in operation 1022, and may call the OnResume( ) function for the second application in operation 1023. The second application 1002 may be in the foreground state again.

According to an embodiment, the multi-window manager 1004 may control the activity manager 1003 such that the first application 1001 has the focus for a predetermined time period (e.g., 500 msec) in operation 1024. The activity manager 1003 may call the OnPause( ) function for the second application 1002, having the focus, in operation 1025, and may call the OnResume( ) function for the first application in operation 1026. For example, the first application 1001 may be in the foreground state again. When a task for initial execution is completed in the state in which the first application 1001 is in the foreground state, the electronic device 101 may terminate the initialization of the first application 1001. The electronic device 101 may perform control such that an execution screen of the first application 1001 is displayed in the user interface 1005 in operation 1027 when the task for initial execution of the first application 1001 is completed.

According to an embodiment, the multi-window manager 1004 may control the activity manager 1003 such that the second application 1002 has the focus for a predetermined time period (e.g., 500 msec) in operation 1028. The activity manager 1003 may call the OnPause( ) function for the first application 1001 having the focus in operation 1029, and may call the OnResume( ) function for the second application 1002 in operation 1030. For example, the second application 1002 may be in the foreground state again. When a task for initial execution is completed in the state in which the second application 1002 is in the foreground state, the electronic device 101 may terminate the initialization of the second application 1002. The electronic device 101 may perform control such that an execution screen of the second application 1002 is displayed in the user interface 1005 in operation 1031 when the initial execution of the second application 1002 is completed.

According to an embodiment, the electronic device 101 may provide multiple-windows for the applications at the point in time at which the initialization of the first application 1001 and the second application 1002 are completed, thereby displaying each execution screen.

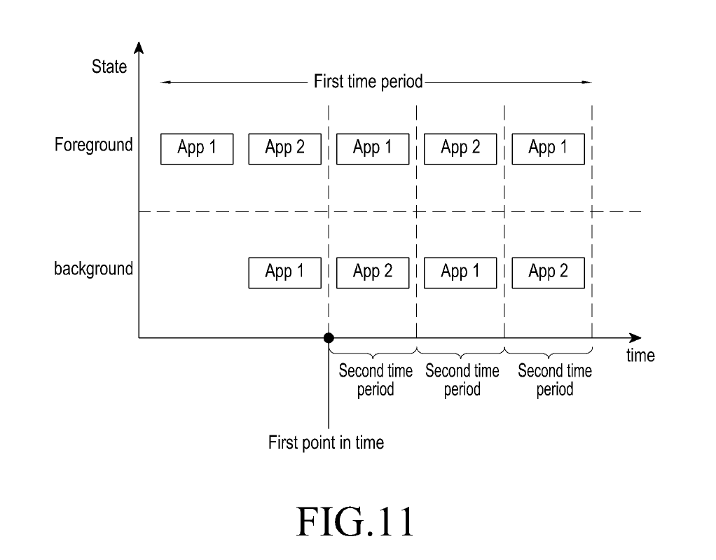

FIG. 11 illustrates a graph of the lifetime state of two applications over time while an electronic device executes the two applications together, according to various embodiments of the present disclosure.

According to various embodiments, an electronic device (e.g., the electronic device 101 of FIG. 1) may perform control such that one application has the focus at a predetermined point in time while the electronic device executes a plurality of applications together. In FIG. 11, a first application is displayed as “APP 1” and a second application is displayed as “APP 2” on the assumption that the initial execution of two applications is requested. In response to the request for executing the two applications, the electronic device 101 may sequentially execute the first application and the second application. In FIG. 11, in response to the execution of the first application, the electronic device 101 may perform control such that the first application has the focus and is in a foreground state. In response to the execution of the second application, the electronic device 101 may perform control such that the second application has the focus. In this instance, the first application is in a background state and the second application is in the foreground state. From a first point in time, the electronic device 101 may perform control such that the first application and the second application alternately have the focus, repeatedly, in order to alternately put the first application and the second application into the foreground state for each second time period. For example, during the first time period, the electronic device 101 may complete the initialization of the first application and the second application.

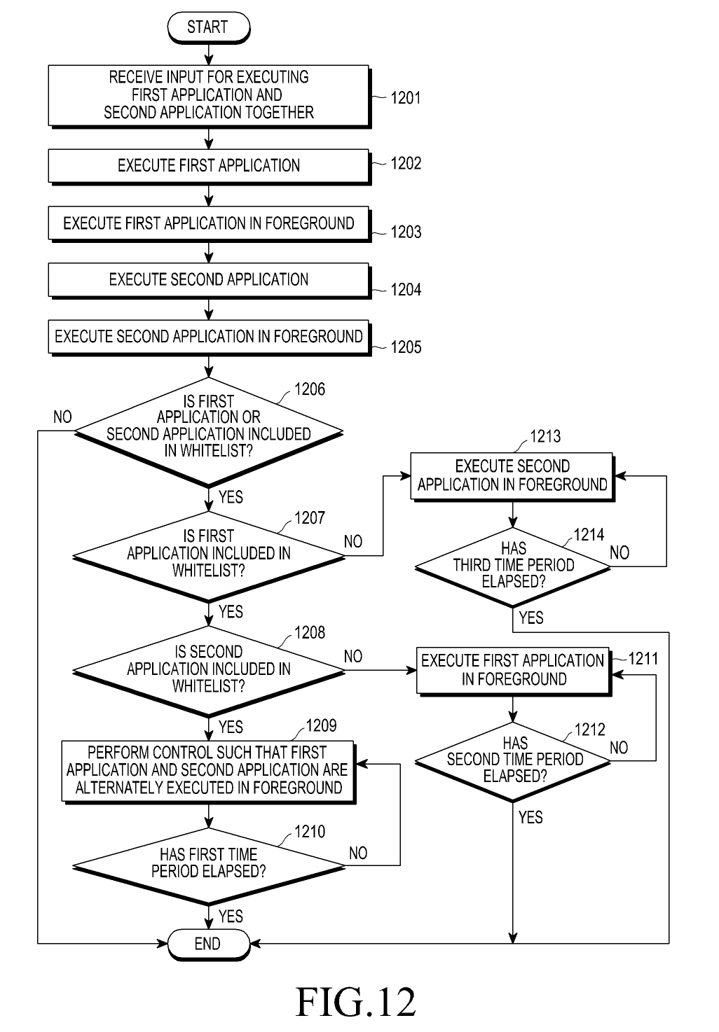

FIG. 12 illustrates a flowchart of a method for controlling a plurality of applications together by an electronic device according to various embodiments of the present disclosure.

In operation 1201, according to various embodiments, an electronic device (e.g., the electronic device 101 of FIG. 1) may receive input for executing a first application and a second application together. For example, the input may be a user touch input on a shortcut icon.

In operation 1202, the electronic device 101 may execute the first application. For example, a series of functions for executing the first application may be called. According to various embodiments, the electronic device 101 may identify the priorities set for the first application and the second application, and may determine that an application having a high priority has priority over the other application. The electronic device 101 may determine that the first application has priority, and may execute the first application first and the second application somewhat later. For example, at the point in time at which the series of operations of FIG. 12 is terminated, the electronic device 101 may perform control such that the first application, having priority, has the focus.

In operation 1203, the electronic device 101 may execute the first application in the foreground. For example, when the electronic device 101 calls an OnResume( ) function for the first application, it is considered that the first application is in the foreground state.

In operation 1204, the electronic device 101 may execute the second application. For example, the electronic device 101 may call a series of functions for executing the second application.

In operation 1205, the electronic device 101 may execute the second application in the foreground. For example, the electronic device 101 may put the first application in the background state, and may put the second application in the foreground state. For example, when the electronic device 101 calls an OnPause function for the first application and calls an OnResume function for the second application, the first application is in the background state and the second application is in the foreground state.

In operation 1206, the electronic device 101 may determine whether the first application or the second application is included in a whitelist. An application that is included in the whitelist is considered to be an application that requires the focus, such as an application that frequently uses resources during initialization or execution. For example, the whitelist may include a document-editing application, a multimedia application, a map application, a cloud server application, and the like.

When the first application and the second application are not included in the whitelist, the electronic device 101 does not execute operation 1207, and terminates operation. According to various embodiments, when the first application does not have the focus, the electronic device 101 may allocate the focus to the first application, having priority, and may terminate operation. When the first application or the second application is included in the whitelist, the electronic device 101 may execute operation 1207. According to various embodiments, when it is determined that the first application or the second application is included in the whitelist, the electronic device 101 may execute operation 1209. For example, when at least one of the first application and the second application is included in the whitelist, control is performed such that the first application and the second application are alternately executed in the foreground.

In operation 1207, the electronic device 101 may determine whether the first application is included in the whitelist. When the first application is included in the whitelist, the electronic device 101 may execute operation 1208. When the first application is not included in the whitelist, the electronic device 101 may execute the second application in the foreground so as to repeatedly allocate the focus to the second application in operation 1213.

In operation 1208, the electronic device 101 may determine whether the second application is included in the whitelist. When the second application is included in the whitelist, the electronic device 101 may alternately allocate the focus to the first application and the second application, repeatedly, in operation 1209. When the second application is not included in the whitelist, the electronic device 101 may execute the first application in the foreground so as to repeatedly allocate the focus to the first application in operation 1211.

In operation 1209, the electronic device 101 may perform control such that the first application and the second application are alternately executed in the foreground. For example, the electronic device 101 may call a pause function (e.g., an OnPause( ) function) for the second application such that the second application, in the foreground state, is executed in the background, and may call a resume function (e.g., an OnResume( ) function) for the first application such that the first application is executed in the foreground. As another example, the electronic device 101 may call a pause function (e.g., an OnPause( ) function) for the first application such that the first application, which is in the foreground state, is executed in the background, and may call a resume function (e.g., an OnResume( ) function) for the second application such that the second application is executed in the foreground.

In operation 1210, the electronic device 101 may determine whether a first time period elapses. For example, the electronic device 101 may determine, as the first time period, the greatest value among the values corresponding to times expended for initialization for initial execution of the first application and the second application. According to various embodiments, when a threshold time for initialization of the first application or the second application elapses, the electronic device 101 may determine that the first time period elapses. As another example, when input for the first application or the second application is detected, the electronic device 101 may determine that the first time period elapses. As another example, when the screen of the display (e.g., the display device 160) of the electronic device 101 is turned off, the electronic device 101 may determine that the first time period elapses. The electronic device 101 repeats operation 1209 during the first time period so as to alternately allocate the focus to the first application and the second application. When the first time period elapses, the electronic device 101 does not execute operation 1209 any longer, and may terminate operation. For example, upon termination, the electronic device 101 may perform control such that the first application, having priority, has the focus.

In operation 1211, the electronic device 101 may execute the first application in the foreground so as to repeatedly allocate the focus to the first application. For example, the electronic device 101 may call a pause function (e.g., an OnPause( ) function) for the second application such that the second application is executed in the background, and may call a resume function (e.g., an OnResume( ) function) for the first application such that the first application is executed in the foreground.

In operation 1212, the electronic device 101 may determine whether a second time period elapses. For example, the electronic device 101 may determine, as the second time period, the time expended for initialization for initial execution of the first application. The electronic device 101 repeats operation 1211 during the second time period so as to alternately allocate the focus to the first application. For example, after allocating the focus to the first application, the focus may be reallocated to the second application in response to a request from the second application. The electronic device 101 may repeatedly allocate the focus such that the first application is executed in the foreground during the second time period. When the second time period elapses, the electronic device 101 does not execute operation 1211 any longer, and may terminate operation. For example, upon termination, the electronic device 101 may perform control such that the first application, having priority, has the focus.

In operation 1213, the electronic device 101 may execute the second application in the foreground so as to repeatedly allocate the focus to the second application. For example, the electronic device 101 may call a pause function (e.g., an OnPause( ) function) for the first application such that the first application is executed in the background, and may call a resume function (e.g., an OnResume( ) function) for the second application such that the second application is executed in the foreground.

In operation 1214, the electronic device 101 may determine whether a third time period elapses. For example, the electronic device 101 may determine, as the third time period, the time expended for initialization for initial execution of the second application. The electronic device 101 repeats operation 1213 during the third time period so as to repeatedly allocate the focus to the second application. For example, after allocating the focus to the second application, the focus may be reallocated to the first application upon request from the first application. The electronic device 101 may repeatedly allocate the focus such that the second application is executed in the foreground during the third time period. When the third time period elapses, the electronic device 101 does not execute operation 1213 any longer, and may terminate operation. For example, upon termination, the electronic device 101 may perform control such that the first application, having priority, has the focus.

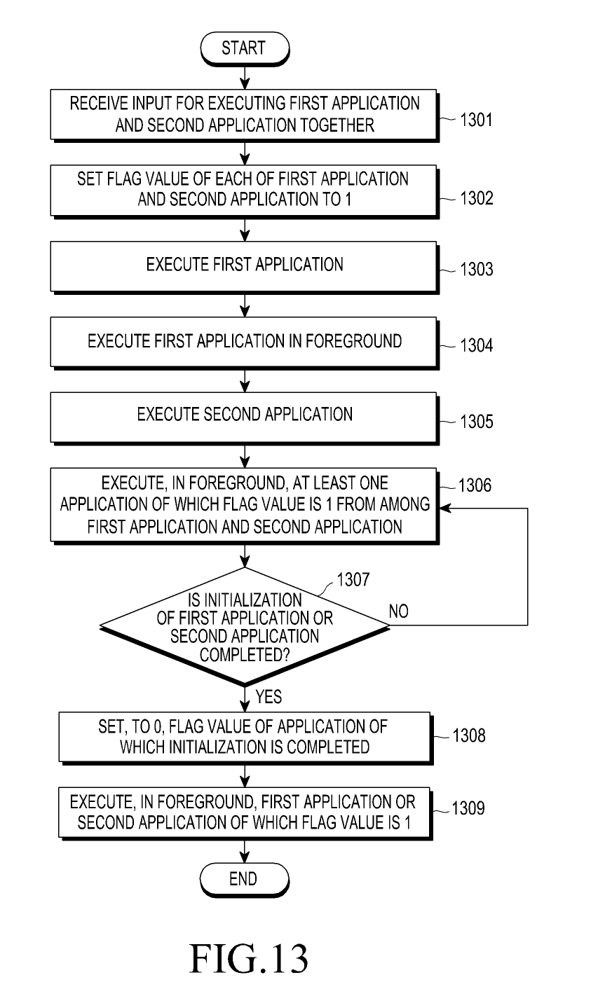

FIG. 13 illustrates a flowchart of a method for controlling a plurality of applications together by an electronic device according to various embodiments of the present disclosure.

In operation 1301, according to various embodiments, an electronic device (e.g., the electronic device 101 of FIG. 1) may receive input for executing a first application and a second application together.

In operation 1302, the electronic device 101 may set flag values of both the first application and the second application to 1. For example, the flag value may be an identification value for continuously providing the focus for securing a stable initialization process for initial execution of an application. For example, when the flag value of the first application is 1, the electronic device 101 may call an OnResume( ) function such that the first application has the focus. As another example, when the flag value of the second application is 1, the electronic device 101 may call an OnResume( ) function such that the second application has the focus. For example, both the first application and the second application may temporarily have the focus.

In operation 1303, the electronic device 101 may execute the first application. For example, a series of functions for executing the first application may be called. According to various embodiments, the electronic device 101 may identify the priorities set for the first application and the second application, and may determine that an application having a high priority has priority over the other application. When it is determined that the first application has priority, the electronic device 101 may execute the first application first in operation 1303, and may execute the second application in operation 1305. At the point in time at which the series of operations of FIG. 13 is terminated, the electronic device 101 may perform control such that the first application, having priority, has the focus.

In operation 1304, the electronic device 101 may execute the first application in the foreground. For example, when the electronic device 101 calls an OnResume( ) function for the first application, and may execute the first application in the foreground state. In the state in which the first application is in the foreground state, the electronic device 101 may execute initialization of the first application.

In operation 1305, the electronic device 101 may start a second application. For example, a series of functions for executing the second application may be called.

In operation 1306, the electronic device 101 may execute, in the foreground, at least one application, the flag value of which is 1, from among the first application and the second application. For example, when both the first application and the second application have the flag value of 1, the electronic device 101 may execute both the first application and the second application in the foreground. For example, both the first application and the second application may temporarily have the focus.

In operation 1307, the electronic device 101 may determine whether initialization of the first application or the second application is completed. When it is determined that any application is not completely initialized, the electronic device 101 may execute operation 1306 to complete the initialization. As another example, when it is determined that an application, the initialization of which is completed, exists, the electronic device 101 may execute operation 1308. According to various embodiments, when the threshold time for the initialization of the first application or the second application elapses, the electronic device 101 may determine that the initialization of the first application or the second application is completed. As another example, when input for the first application or the second application is detected, the electronic device 101 may determine that the initialization of the first application or the second application is completed. As another example, when the screen of the display (e.g., the display device 160) of the electronic device 101 is turned off, the electronic device 101 may determine that the initialization of the first application or the second application is completed.

In operation 1308, the electronic device 101 may change and set, to 0, the flag value for the application, the initialization of which is completed. For example, when the initialization of the first application is completed, the electronic device 101 may change the flag value of the first application to 0. When the initialization of the second application is completed, the electronic device 101 may change the flag value of the second application to 0. According to an embodiment, when the flag value of an application is 0, the electronic device 101 may determine that initialization for initial execution of the application is completed.

In operation 1309, the electronic device 101 executes the first application or the second application, the flag value of which is 1, in the foreground. For example, when the flag value of the first application is changed to 0 in operation 1308, the electronic device 101 may execute the second application in the foreground. As another example, when the flag value of the second application is changed to 0 in operation 1308, the electronic device 101 may execute the first application in the foreground.

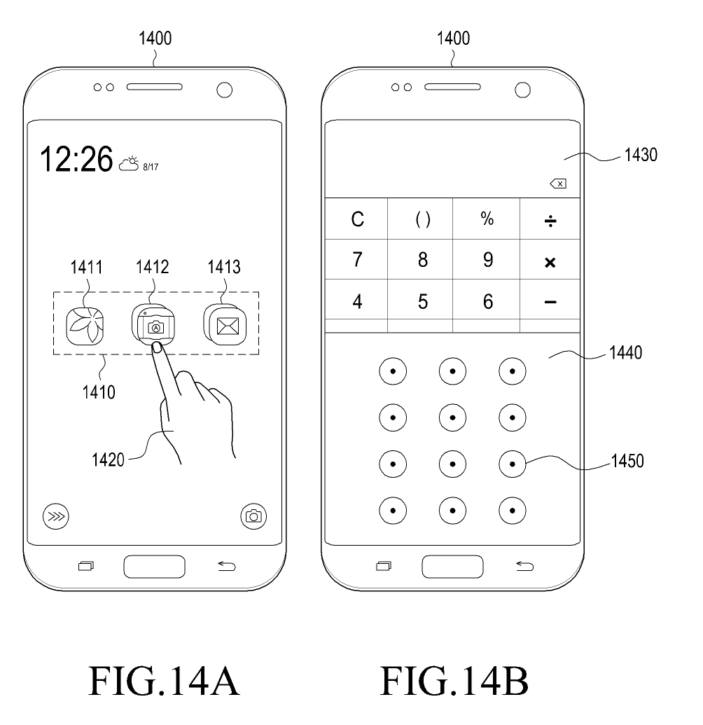

FIGS. 14A and 14B illustrate diagrams of an example situation of executing a plurality of applications together on a lock screen by an electronic device according to various embodiments of the present disclosure.

According to various embodiments, an electronic device 1400 (e.g., the electronic device 101 of FIG. 1) may display, on a lock screen, a shortcut icon for executing a plurality of applications together. Referring to FIG. 14A, the electronic device 1400 may display shortcut icons 1411, 1412, and 1413 in an area 1410 for providing a menu on the lock screen of a display. In a locked state, the electronic device 1400 may receive input 1420 on the shortcut icon 1412 for executing a calculator application and a camera application together. In response to the input 1420, the electronic device 1400 may provide the calculator application and the camera application in multiple-windows. When an application requires unlocking, the electronic device 101 may, for example, provide a user interface for requiring unlocking of the application. As another example, when the application does not require unlocking, the electronic device 101 may provide an execution screen of the application in response to a request for execution. Referring to FIG. 14B, when it is determined that the camera application requires unlocking and that the calculator application does not require unlocking, the electronic device 101 may display the calculator application in the upper portion 1430 of the multi-window, may display the camera application in the lower portion 1440 of the multi-window, and may provide a user interface 1450 for unlocking the camera application.

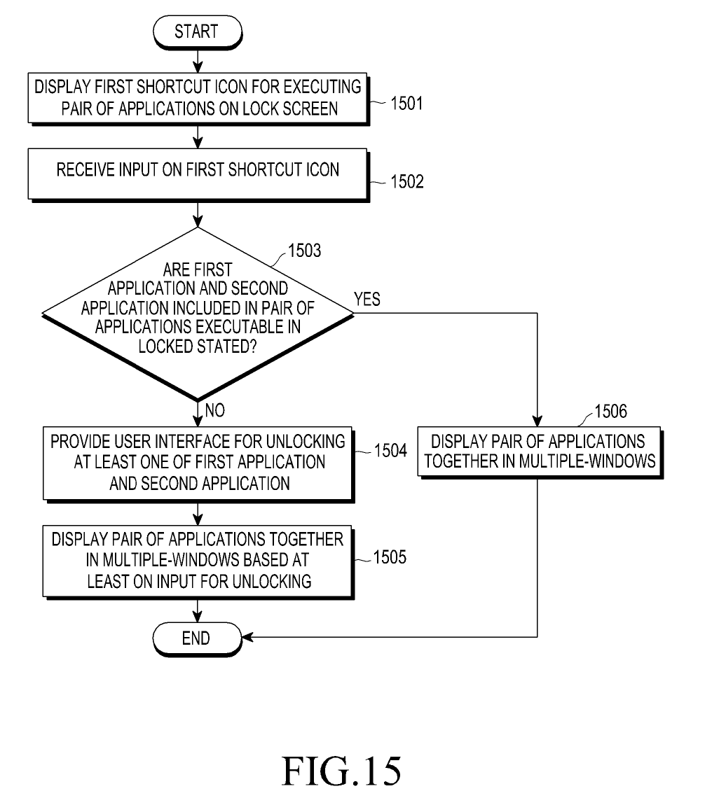

FIG. 15 illustrates a flowchart of a method for executing a plurality of applications together by an electronic device on a lock screen according to various embodiments of the present disclosure.

In operation 1501, according to various embodiments, the electronic device 101 (e.g., the processor 120), may display a first shortcut icon for executing a pair of applications on a lock screen. For example, the first shortcut icon may be displayed by combining an icon for a first application and an icon for a second application. The pair of applications may include the first application and the second application. On the assumption that the priority of the first application is higher than the priority of the second application, the electronic device 101 may dispose the first application, having higher priority, in the upper portion of a multi-window.

In operation 1502, the electronic device 101 may receive input on the first shortcut icon.

In operation 1503, the electronic device 101 may determine whether the first application and the second application included in the pair of applications are executable in a locked state. When at least one of the first application and the second application is not executable in a locked state, the electronic device 101 may execute operation 1504. When the first application and the second application are executable in the locked state, the electronic device 101 may execute operation 1506.

In operation 1504, the electronic device 101 may provide a user interface for unlocking at least one of the first application and the second application. For example, the electronic device 101 may display a user interface for inputting a pattern for unlocking. As another example, when the first application is not executable in the locked state, the electronic device 101 may identify and change the layout of the first application and the second application before requesting unlocking of the first application. For example, when the first application is disposed in the upper portion of a multi-window and the second application is disposed in the lower portion of the multi-window, the electronic device 101 may change the layout such that the first application, which requires unlocking, is disposed in the lower portion of the multi-window, since the user interface for unlocking may be provided in the lower portion of the multi-window so as to increase the convenience of the user.

In operation 1505, the electronic device 101 may display the pair of applications together in the multi-window based at least on the input for unlocking. For example, the electronic device 101 may display the first application, having a high priority, in a sub-window disposed in the upper portion of the multi-window UI, and may display the second application, having a relatively low priority, in a sub-window disposed in the lower portion of the multi-window UI.

In operation 1506, the electronic device 101 may display the pair of applications together in the multi-window. For example, the electronic device 101 may display the execution screens of the applications in the multi-window without requesting unlocking of the first application or the second application.

An electronic device according to various embodiments disclosed herein may be various types of devices. The electronic device may, for example, include at least one of a portable communication device (e.g., smartphone) a computer device, a portable multimedia device, a portable medical device, a camera, a wearable device, and a home appliance. The electronic device according to one embodiment is not limited to the above described devices.

The embodiments and the terms used therein are not intended to limit the technology disclosed herein to specific forms, and should be understood to include various modifications, equivalents, and/or alternatives to the corresponding embodiments. In describing the drawings, similar reference numerals may be used to designate similar constituent elements. A singular expression may include a plural expression unless they are definitely different in a context. The terms “A or B”, “one or more of A and/or B”, “A, B, or C”, or “one or more of A, B and/or C” may include all possible combinations of them. The expression “a first”, “a second”, “the first”, or “the second” used in various embodiments may modify various components regardless of the order and/or the importance but does not limit the corresponding components. When an element (e.g., first element) is referred to as being “(functionally or communicatively) connected,” or “directly coupled” to another element (second element), the element may be connected directly to the another element or connected to the another element through yet another element (e.g., third element).

The term “module” as used herein may include a unit consisting of hardware, software, or firmware, and may, for example, be used interchangeably with the term “logic”, “logical block”, “component”, “circuit”, or the like. The “module” may be an integrated component, or a minimum unit for performing one or more functions or a part thereof. For example, a module may be an Application-Specific Integrated Circuit (ASIC).

Various embodiments disclosed herein may be implemented by software (e.g., program 240) including an instruction stored in machine-readable storage media (e.g., internal memory 136 or external memory 138). The machine is a device that calls the stored instruction from the storage media and can operate according to the called instruction, and may include an electronic device (e.g., electronic device 101) according to the disclosed embodiments. The instruction, when executed by a processor (e.g., processor 120), may cause the processor to directly execute a function corresponding to the instruction or cause other elements to execute the function under the control of the processor. The instruction may include a code that is generated or executed by a compiler or interpreter. The machine-readable storage media may be provided in the form of non-transitory storage media. Here, the term “non-transitory” only means that the storage media is tangible without including a signal, irrespective of whether data is semi-permanently or transitorily stored in the storage media.

According to an embodiment, the method according to various embodiments disclosed in the present document may be provided by being included in a computer program product. The computer program product may be traded between a seller and a purchaser as a product. The computer program product may be distributed online in the form of a machine-readable storage medium (e.g., a compact disc read only memory (CD-ROM)) or via an application store (e.g., PLAY STORE). In the case of online distribution, at least a part of the computer program product may be at least temporarily stored or temporarily generated in a storage medium, such as the server of a manufacturing company, the server of an application store, or the memory of a relay server.

Each element (e.g., module or program) according to various embodiments may be configured to include a single entity or multiple entities, and some sub-elements of the above-described sub-elements may be omitted, or other sub-elements may be further included. Alternatively or additionally, some elements (e.g., modules or programs) may be integrated into a single entity, and may perform functions which are the same as or similar to the functions executed by corresponding elements before they are integrated. Operations performed by a module, a programming module, or other elements according to various embodiments may be executed sequentially, in parallel, repeatedly, or in a heuristic manner. At least some operations may be executed according to another sequence, may be omitted, or may further include other operations.

Various embodiments disclosed herein are provided merely to easily describe technical details of the present disclosure and to help the understanding of the present disclosure, and are not intended to limit the scope of the present disclosure. Therefore, it should be construed that all modifications and changes or modified and changed forms based on the technical idea of the present disclosure fall within the scope of the present disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device comprising:
a housing;
a touch screen display exposed through a portion of the housing;
a wireless communication circuit positioned in the housing;
a processor electrically connected to the touch screen display and the wireless communication circuit; and
a memory electrically connected to the processor, wherein the memory is configured to store:
a first application program including a first user interface,
a second application program including a second user interface, and
instructions, and
wherein the processor is configured to:
display an array of icons on the touch screen display,
wherein each of the icons are a first size, and
wherein at least one of the array of icons includes a first object and a second object that are a second size, wherein the second size is smaller than the first size, and wherein the first object represents the first application program and the second object represents the second application program;
receive an input to select one of the at least one of the array of icons;
from a first point in time, display the first user interface and the second user interface in sequence on the touch screen display upon receiving the input; and
repeatedly run the first application program and the second application program alternately in a foreground during a first time period from the first point in time.

2. The electronic device of claim 1, wherein the instructions are associated with an ANDROID operating system (OS), and wherein the processor is further configured to, from after the first point in time, in sequence:
provide an onCreate method to the first application program;
provide an onStart method to the first application program,
provide an onResume method to the first application program;
provide an onCreate method to the second application program;
provide an onStart method to the second application program;
provide an onPause method to the first application program;
provide an onResume method to the second application program;
provide an onPause method to the second application program;
provide an onResume method to the first application program;
provide an onPause method to the first application program; and
provide an onResume method to the second application program.

3. The electronic device of claim 2, wherein to repeatedly run the first application program and the second application program alternately in the foreground, the processor is further configured to, in sequence:
provide an onPause method to the second application program;
provide an onResume method to the first application program;
provide an onPause method to the first application program; and
provide an onResume method to the second application program.

4. The electronic device of claim 1, wherein the processor is further configured to display the first user interface and the second user interface on the touch screen display, wherein the first user interface and the second user interface are the same size.

5. The electronic device of claim 4, wherein to display the first user interface and the second user interface on the touch screen display, the processor is further configured to display the first user interface and the second user interface in contact along a boundary extending perpendicular to an edge of the touch screen display.

6. The electronic device of claim 5, wherein the touch screen display is a rectangular shape including a first side of a first length, and a second side of a second length that is longer than the first length, and wherein the edge is at least a portion of the second side.

7. The electronic device of claim 1, wherein the first time period is in a range from 2 seconds to 4 seconds.

8. The electronic device of claim 1, wherein a priority set for the first application program is higher than a priority set for the second application program, and
wherein the processor is further configured to:
compare the priority set for the first application program and the priority set for the second application program; and
preferentially run the first application program based at least on a comparison result.

9. The electronic device of claim 1, wherein the processor is further configured to:
display the first user interface as a first pop-up window on the touch screen display;
and display the second user interface as a second pop-up window on the touch screen display,
wherein at least a part of the second pop-up window is visible.

10. A method of controlling multiple-windows by an electronic device, the method comprises:
displaying an array of icons on a touch screen display of the electronic device,
wherein each icon are a first size, and
wherein at least one of the array of icons includes a first object and a second object that are a second size, wherein the second size is smaller than the first size, and wherein the first object represents a first application program and the second object represents a second application program;
receiving an input for selecting one of the at least one of the array of icons;
from a first point in time, displaying, a first user interface and a second user interface in sequence on the touch screen display upon receiving the input; and
repeatedly running the first application program and the second application program alternately in a foreground during a first time period from the first point in time.

11. The method of claim 10, wherein the electronic device includes an ANDROID operating system (OS), and wherein from the first point in time, the method includes in sequence:
providing an onCreate method to the first application program;
providing an onStart method to the first application program;
providing an onResume method to the first application program;
providing an onCreate method to the second application program;
providing an onStart method to the second application program;
providing an onPause method to the first application program;
providing an onResume method to the second application program;
providing an onPause method to the second application program;
providing an onResume method to the first application program;
providing an onPause method to the first application program; and
providing an onResume method to the second application program.

12. The method of claim 11, wherein to repeatedly run the first application program and the second application program alternately in the foreground, the method includes, in sequence:
providing an onPause method to the second application program;
providing an onResume method to the first application program;
providing an onPause method to the first application program; and
providing an onResume method to the second application program.

13. The method of claim 10, wherein to display the first user interface and the second user interface in sequence the method comprises displaying the first user interface and the second user interface on the touch screen display, wherein the first user interface and the second user interface are same size.

14. The method of claim 13, wherein to display the first user interface and the second user interface on the touch screen display, the method comprises displaying the first user interface and the second user interface in contact along a boundary extending perpendicular to an edge of the touch screen display.

15. The method of claim 14, wherein the touch screen display is a rectangular shape including a first side of a first length, and a second side of a second length that is longer than the first length, and wherein the edge is at least a portion of the second side.

16. The method of claim 10, wherein the first time period is in a range from 2 seconds to 4 seconds.

17. The method of claim 10, wherein a priority set for the first application program is higher than a priority set for the second application program, and
the method further comprises:
comparing the priority set for the first application program and the priority set for the second application program; and
preferentially running the first application program based at least on a comparison result.

18. The method of claim 10, wherein the displaying of the first user interface and the second user interface in sequence comprises:
displaying the first user interface as a first pop-up window on the touch screen display; and
displaying the second user interface as a second pop-up window on the touch screen display, and
wherein at least a part of the second pop-up window is visible.

19. A computer-readable medium embodying a computer program, the computer program comprising computer readable program code that when executed by a processor of an electronic device, causes the processor to:
display an array of icons on a touch screen display,
wherein each icon are a first size, and
wherein at least one of the array of icons includes a first object and a second object that are a second size, wherein the second size is smaller than the first size, and wherein the first object represents a first application program and the second object represents a second application program;
receive an input for selecting one of the at least one of the array of icons;
from a first point in time, display a first user interface and a second user interface in sequence on the touch screen display upon receiving the input; and
repeatedly run the first application program and the second application program alternately in a foreground during a first time period from the first point in time.

20. The computer-readable medium of claim 19, wherein the computer-readable medium further comprises an ANDROID operating system (OS), and wherein from the first point in time, the computer-readable medium further comprises program code that, when executed at the processor, causes the processor to in sequence:
provide an onCreate method to the first application program;
provide an onStart method to the first application program;
provide an onResume method to the first application program;
provide an onCreate method to the second application program;
provide an onStart method to the second application program;
provide an onPause method to the first application program;
provide an onResume method to the second application program;
provide an onPause method to the second application program;
provide an onResume method to the first application program;
provide an onPause method to the first application program; and
provide an onResume method to the second application program.
